(19) United States
(12) Patent Application Publication
(10) Pub. No.: US 2013/0046590 A1
(43) Pub. Date: Feb. 21, 2013

(54) JOINT PURCHASING METHODS AND SYSTEMS

(71) Applicants: Talila ABRAHAM, Kfar-Truman (IL); Mordechai Abraham, Kfar-Truman (IL)

(72) Inventors: Talila ABRAHAM, Kfar-Truman (IL); Mordechai Abraham, Kfar-Truman (IL)

(21) Appl. No.: 13/214,194

(22) Filed: Aug. 21, 2011

(51) Int. Cl. G06Q 30/00

(52) U.S. Cl. 705/14.1; 705/14.58

(57) ABSTRACT

A method of coordinating a joint purchase between a plurality of subscribers. The method comprises monitoring the location of each of a plurality of subscribers, receiving from a first of the plurality of subscribers an indication of a joint purchase for a suggested deal in an offering location, calculating a group of the plurality of subscribers who are located in proximity to the offering location, sending at least one invitation indicative of the suggested deal to at least one member of the group, receiving at least one response to the at least one invitation from the at least one member, and coordinating the joint purchase between the first subscriber and the at least one member.

### FIELD AND BACKGROUND OF THE INVENTION

The present invention, in some embodiments thereof, relates to group purchasing and, more particularly, but not exclusively, to systems of sharing information about commercial offers for group purchasing.

Conventionally, a group purchasing system enables a plurality of purchasers to make a collective application for purchasing of a product of the same kind, and to receive a price discount at the time of purchasing the product. The group purchasing system gathers the purchasers in advance, and gives the price discount to the purchasers when the purchasers make a package deal contract with a dealer for purchasing a product.

For example, Japanese Patent Application Laid-open No. 2002-215998) discloses a price discount method for group purchasing that is designed to receive a product purchasing application from a plurality of purchasers via the Internet within a predetermined period, and set a higher price discount rate when the number of applicants for purchasing the product becomes larger.

According to the conventional group purchasing system, the purchasers cannot obtain the product until the package deal contract of the product is completed. Therefore, purchasers who want to purchase a product at an early date cannot participate in the group purchasing. Since a price discount rate is determined for the corresponding number of purchasers, the package deal contract is not completed earlier, and as a result, the purchasers cannot obtain the product earlier.

### SUMMARY OF THE INVENTION

According to some embodiments of the present invention, there is provided a method of coordinating a joint purchase. The method comprises monitoring the location of each of a plurality of subscribers, receiving from a first of the plurality of subscribers an indication of a joint purchase of a suggested deal of a plurality of products in an offering location, calculating a group of the plurality of subscribers who are located in proximity to the offering location, sending at least one invitation indicative of the suggested deal to at least one member of the group, receiving at least one response to the at least one invitation from the at least one member, and coordinating the joint purchase between the first subscriber and the at least one member.

Optionally, the suggested deal is designated for a single purchase by a single customer.

Optionally, the receiving further comprises receiving price and content details pertaining to the suggested deal from the first subscriber; wherein the sending further comprises sending the price and content details to the at least one member.

Optionally, the receiving further comprises receiving gathering location data pertaining to the suggested deal from the first subscriber; wherein the sending further comprises sending the gathering location data to the at least one member.

Optionally, the suggested deal is an offer to purchase a plurality of articles at a discounted rate in relation to purchasing each the article separately.

Optionally, the calculating further comprises identifying shopping interests of each the subscriber and filtering the group according to a match between respective the shopping interests of the at least one member and at least one

Optionally, the calculating further comprises identifying privacy preferences of each member of the group and filtering the group according to a match between the respective privacy preferences and at least one characteristic of the first subscriber.

Optionally, the calculating further comprises providing a plurality of social connections among the plurality of subscribers and using the plurality of social connections to identify the group based on social connections of the first subscriber.

Optionally, the method further comprises managing a database of a plurality of suggested deals each associated with locational data; wherein the receiving comprises presenting at least some of the plurality of suggested deals to the first subscriber based its location and receiving from the first subscriber a selection indicative of one of the plurality of suggested deals.

Optionally, the suggested deal is for a plurality of articles; further comprising calculating a distribution of the plurality of articles among participants in the joint purchase and a respective discount per participant; wherein the sending further comprises sending the respective discount and the distribution to the at least one member.

Optionally, the method further comprises managing a plurality of subscriber ranks each for another the subscriber, receiving a report indicative of the outcome of the joint purchase from at least one of the first subscriber and the at least one member and updating a respective the subscriber rank accordingly.

Optionally, the receiving comprises analyzing a navigation query of the first subscriber to extract the offering location, presenting the suggested deal to the first subscriber, and receiving a selection of the suggested deal by the first subscriber.

Optionally, the calculating comprises identifying at least one of the plurality of subscribers who set a navigation destination in proximity to the offering location and adding the at least one member to the group.

Optionally, the calculating comprises identifying at least one of the plurality of subscribers who set a navigation route that passes in proximity to the offering location and adding the at least one member to the group.

Optionally, the method further comprises receiving an indication of the execution of the joint purchase and updating a credibility rank of at least one of the first subscriber and the at least one member accordingly.

A computer readable medium comprising computer executable instructions adapted to perform the method which is outlined above and described below.

Optionally, the method further comprises acquiring a payment proof from a payment server and notifying the first subscriber about the acquisition.

According to some embodiments of the present invention, there is provided a system of coordinating a joint purchase. The system comprises a database of a plurality of subscribers each associated with current locational data, a central unit, and a plurality of client modules, each installed in one of a plurality of client terminals and configured to receive a purchasing request indicative of a suggested deal in an offering location from a first of the plurality of subscribers, to extract a respective the locational data from a hosting the client terminal, and to forward the purchasing request and the respective locational data to the central unit. The central unit identifies a group of the plurality of subscribers who are located in proximity to the offering location according to the respective locational data, sends at least one invitation to at least one member of the group, and coordinate a joint purchase according to at least one response of the at least one member to the at least one invitation.

According to some embodiments of the present invention, there is provided a method of coordinating a joint purchase. The method comprises providing locational data of a plurality of subscribers, identifying a group of the plurality of subscribers who is or about to be in proximity to an offering location of a suggested deal of a plurality of products according to the locational data, sending an invitation indicative a joint purchase of the plurality of products to a plurality of members of the group, receiving a plurality of responses to the invitation from at least some of the plurality of members, and coordinating the joint purchase between the at least some plurality of members.

Optionally, the locational data comprises a plurality of navigation destinations of the plurality of subscribers; wherein the identifying comprises identifying which of the plurality of subscribers set a navigation destination in proximity to the offering location.

Optionally, the locational data comprises a plurality of navigation destinations of the plurality of subscribers; wherein the identifying comprises identifying which of the plurality of subscribers set a navigation route passing in proximity to the offering location.

More optionally, the plurality of navigation destinations are received from a plurality of navigation modules each installed in another of a plurality of client terminals.

Optionally, the suggested deal is acquired from a database comprising a plurality of suggested deals each associated with respective locational data based on a match between the offering location and respective the locational data.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a schematic illustration of a communication system of establishing communication and/or coordinating real life meetings among subscribers, for joint purchasing, according to some embodiments of the present invention; and

FIG. 2 is a flowchart of a method of matching between subscribers, according to some embodiments of the present invention; and

FIGS. 3A-3H are a plurality of schematic and exemplary graphical user interfaces, each adapted to another deal type, according to some embodiments of the present invention; and

FIG. 4 is a method of establishing communication among a plurality of subscribers based on location, according to some embodiments of the present invention.

### DESCRIPTION OF EMBODIMENTS OF THE INVENTION

The present invention, in some embodiments thereof, relates to group purchasing and, more particularly, but not exclusively, to systems of sharing information about commercial offers for group purchasing.

According to some embodiments of the present invention, there are provided methods and systems for coordinating a joint purchase among a plurality of subscribers, based on their location. The joint purchase is optionally of a number of products which are suggested in a deal, such as a 1+1 deal, a buy two and pay for one deal, a certain percentage off the second and/or third item deal, a family pack having a plurality of separable units deal, a discount on a quantity deal, and/or the like. This joint purchase is optionally requested by one of the subscribers, which is located near an offering location of the suggested deal. The request is optionally made via client module that is installed in a client terminal, such as a mobile device. In use, the system and/or the method identify a group of subscribers which are and/or about to be located in proximity to the offering location and send an invitation indicative of the deal thereto. Then, one or more responses to the invitation are received. This allows coordinating a joint purchase between the requesting subscriber and the responding subscriber(s).

Optionally, the requesting subscriber provides details pertaining to the deal, for example price, product descriptions, and/or the like. The requesting subscriber may define the distribution of purchased products among participants of the joint purchase, a gathering location and/or time for facilitating a meeting the joint purchase, and/or participation terms, such as payment in advance to a payment service, paying in cash, paying using cellular payment and/or the like.

Optionally, the deal is selected from a database of offers that is initially created and updated by subscribers, the operator of the system, and/or retailers, including advertisers of products and/or services provided by the retailers. Optionally, a ranking mechanism is used to allow subscribers to evaluate the credibility of other subscribers and/or the quality of service and/or credibility of retailers. Optionally, the group of invitees is selected according to the personal setting of the subscribers, such as privacy setting, preferences, and/or shopping interests.

According to some embodiments of the present invention, there are provided methods and systems of coordinating a joint purchase by matching locational data of a plurality of subscribers and identifying a current proximity and/or a near future proximity to a common offering location of a deal. The methods are based on monitoring locational data of a plurality of subscribers, such as a plurality of navigation destinations of navigation modules, such as Google Maps™, WAZE™ TomTom™ and/or the like. This allows identifying a group of subscribers which are or about to be in proximity to the offering location, for example subscribers who set a navigation destination in proximity to the offering location or subscribers who set navigation route passing in proximity to the offering location. Then, an invitation indicative a joint purchase that is based on the deal is sent to members of the group of subscribers which have been identified as located in proximity to the offering location. Optionally, in order to avoid long waiting periods for subscribers to arrive, only subscribers with an estimated arrival time below a certain threshold, optionally manually set by the requesting subscriber, such as 10 minutes or so are invited. After responses to the invitation are received from one or more of the plurality of members, the joint purchase is coordinated between the responding members. This allows setting a joint purchase between subscribers who are located in or in proximity to the offering location and subscribers who will arrive at the offering location in the near future. Optionally, participants of the joint purchase, for example the requesting subscribers and the responding invitees, receive a notification indicative of the distance of the other participants or their estimated arrival time to determine whether they wish to wait or not.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

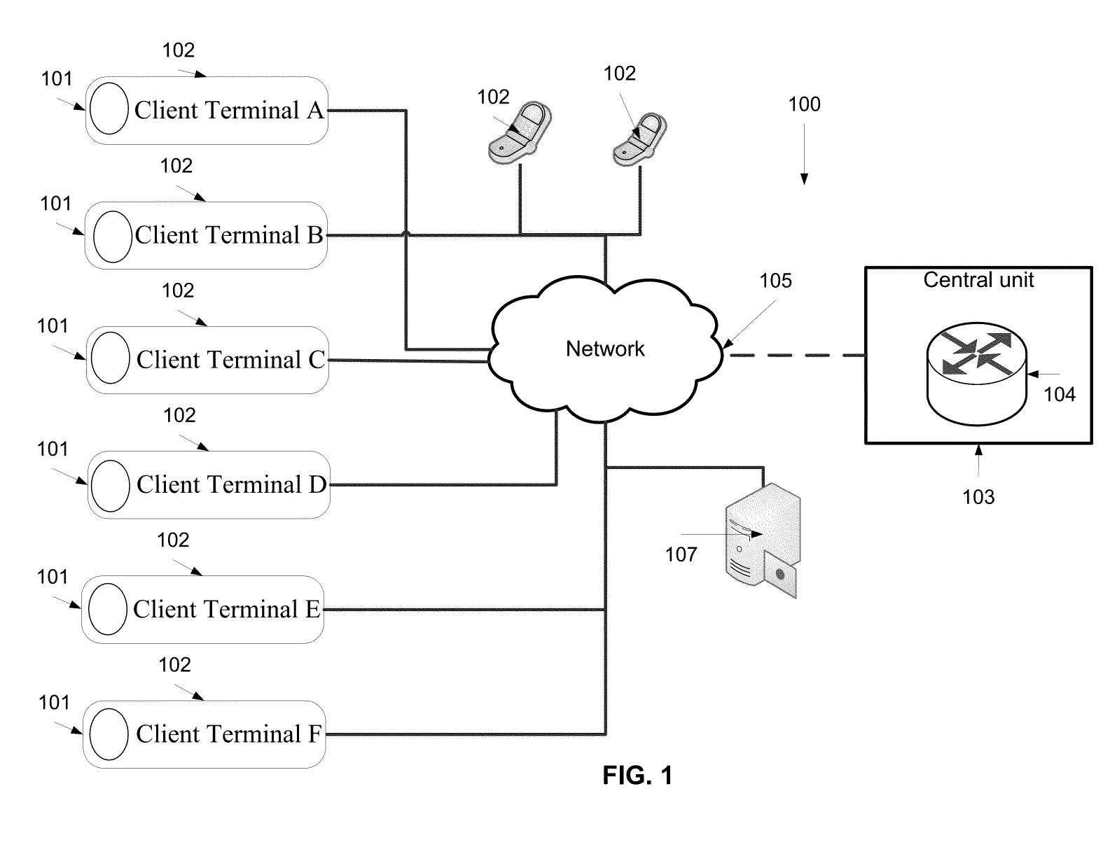

Reference is now made to FIG. 1, which is a schematic illustration of a communication system 100 of establishing communication and/or coordinating real life meetings among subscribers, for example by sending notifications and/or locational data, according to some embodiments of the present invention. As further elaborated below, the system 100 may be used as an infrastructure that allows communication between potential buyers which are located, or about to located, in proximity to one another, notifying them about suggested deals that may be more attractive for a plurality of buyers than a single buyer. These suggested deals, which are optionally designated for a single purchase by a single customer, are referred to herein also as offers, may not be defined as designated for a plurality of purchasers by the offering retailer; however, the system 100 allows a subscriber to designate such an offer for joint purchasing and to recruit one or more other subscribers therefore. For example, the system allows a subscriber to find partners to participate in a group purchasing of a 1+1 deal, a card index deal, a buy two and pay for one deal, a certain percentage off the second item deal, a family pack deal, a quantity discount, and/or the like. Each offer is associated with a respective offering location, namely the physical location of the store and/or warehouse, for example the address at which the subscriber can actually accept the suggested deal.

This system 100 may be used for sending promotional content to subscribers based on their location and/or to their proximity to other subscribers, for example as described below. The system 100 is based on a plurality of client modules 101, such as applications (i.e. AppStore apps), add-ons, and/or a plug-ins, which are installed in a plurality of client terminals 102, such as mobile devices, cellular phones, Smartphones, tablets, and/or designated thin clients. It should be noted that a client module may be an active object that is accessed by a browser of the client terminal 102. In such an embodiment, the client module is not stored in the memory of the client terminal but rather hosted on a web server.

Optionally, each client module 101 is adapted to present a graphical user interface (GUI) that allows receiving user inputs and selections and presenting, based on the location of the subscriber, offers selected by other subscribers as attractive for group purchasing, for example as described below.

The client modules 101 are adapted to communicate with a central unit 103 via a network 105, such as a packet-oriented communication network, for example the internet, for example using a wireless wide area network (WAN) and/or local area network (WLAN) interface, such as Wi-Fi™, 3GPP long term evolution (LTE), and/or WiMAX™ interface of the hosting client terminal 102. Additionally or alternatively, some or all of the client modules 102 are adapted to communicate with the central unit 103 using a cellular data service, such as a general packet radio service (GPRS), general packet radio service (GPRS), EDGE 3G, wireless application protocol (WAP), wideband code division multiple access (WCDMA), and high-speed packet access (HSPA). For brevity, the standards of these interfaces and services are incorporated herein by reference.

Optionally, the communication between each client terminal 102 and the central unit 103 allows each client terminal 102 to transmit its location, for example based on locational data from a global positioning system (GPS) module or assisted GPS (A-GPS) module. Additionally or alternatively, this communication further allows each client terminal 102 to receive location based offers which has been identified as suitable for a group of purchasers by the operator and/or other subscribers. As used herein, a subscriber is a user that is associated with a certain client terminal.

The central unit 103 includes and/or connected to a database 104 that hosts a plurality of subscriber profile records, each with a subscriber identification, for example name and/or social network identity, an address, such as an email, a telephone number, a packet oriented address, such as a unique ID a MAC address, an IP address and the like, an instant messaging identification (ID), and/or a chat ID, and a log that documents its activity, for example purchases made using the system 100. Optionally, each subscriber record includes a credibility rank of the subscriber. The credibility rank is optionally based on the number of transactions the subscriber performed using the system 100, the number of complains which has been filed against the subscriber by other subscribers, and/or the number of offers the subscriber uploads to the system 100, for example as described below.

Optionally, each subscriber record includes preference setting such as shopping interests of the subscriber, for example products and/or services the subscriber has interest in and/or characteristics of the subscribers he is ready to purchase with. The shopping interests are optionally dynamically adjusted by the user, for example using the aforementioned GUI. For example, the subscriber may add a wish list of products and/or services, define a transaction parameter, such as a price range and/or the like.

Optionally, each subscriber record includes personal information about the subscriber which may allow the matching thereof with other subscribers for shopping activity. For example, the information includes demographic information, such as age, gender, marital status, address, and/or the like, hobbies, preferences, an image, a status line and/or the like. Optionally, each subscriber record includes information the subscriber uploads for presentation to other subscribers, for example a text, one or more images, a video file, and/or an audio file. Optionally, the subscriber record includes a reference, such as a link, to a respective social network profile, such as Facebook™, Twitter™, Instagram™ and/or the like. Optionally, the central unit 103 manages a social network graph that defines social connections between the subscribers and/or check social network connections between subscribers based on a social network, such as Facebook™, Twitter™, Instagram™ and/or the like.

Optionally, each subscriber record includes privacy definitions which define with which other subscribers the subscriber is ready to coordinate a group purchasing. In such embodiments, different privacy definitions may apply to communication between subscribers based on the social network connections.

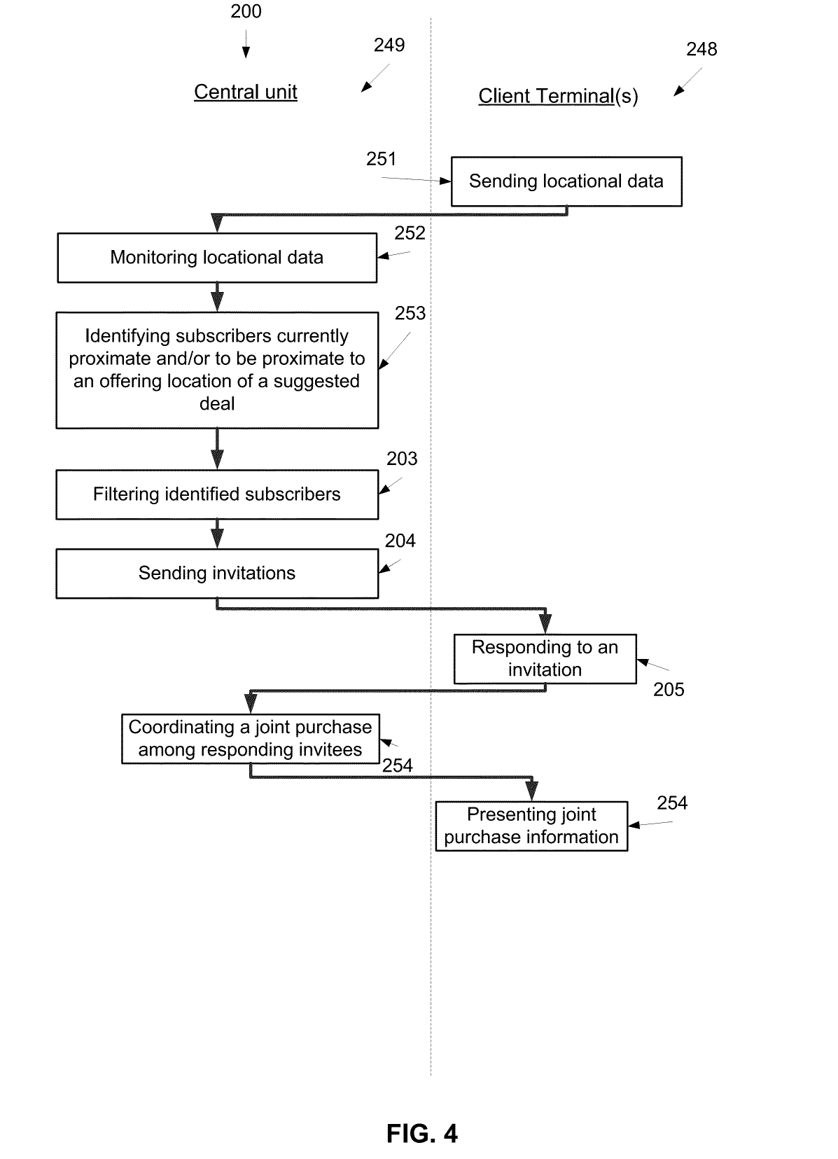

According to some embodiments of the present invention, the database is used for distributing promotional content. In such an embodiment, promotional content, such as advertisements, coupons, text banners, video banners, trailers, and/or the like is send to a subscriber based on the identification of its location and proximity to other subscribers that share common characteristics and/or shopping interests. The advertisements may be sent from an ad server, such as 107, based on instructions from the central unit 103. See, for example FIG. 4 and the respective description below.

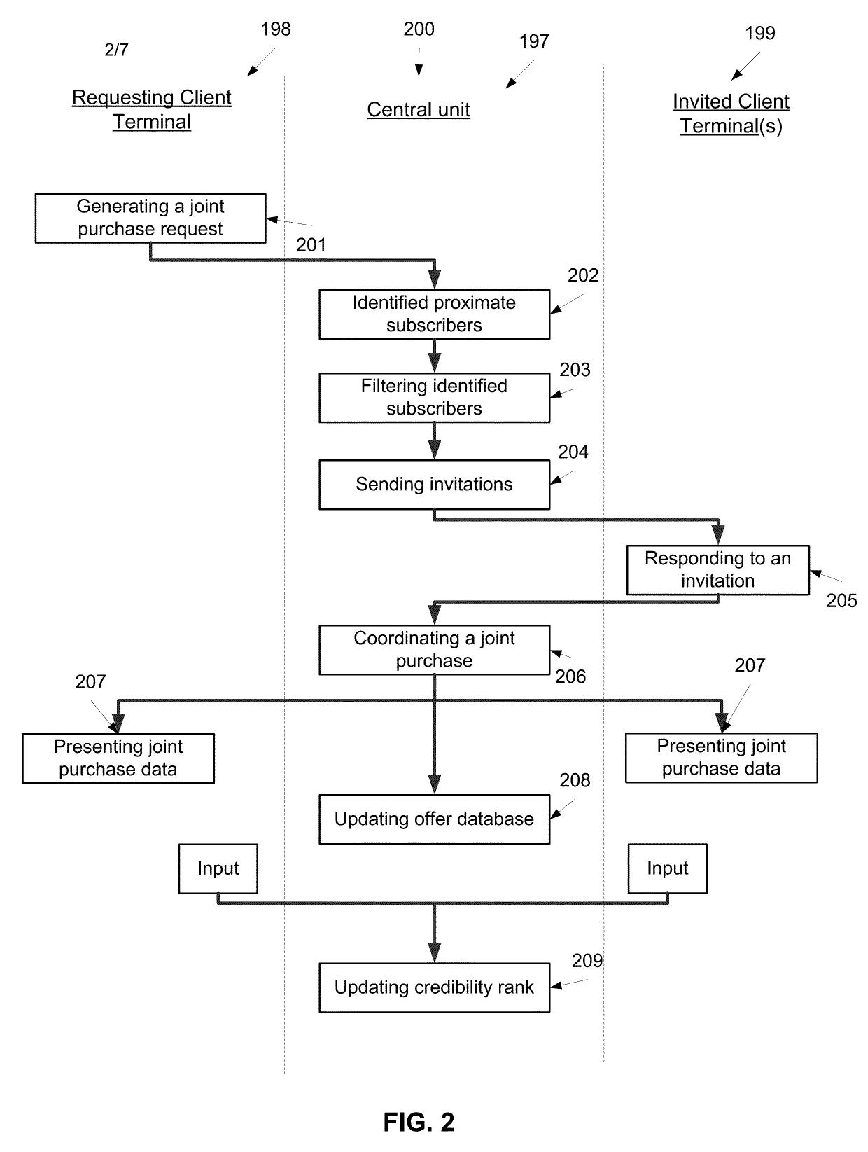

Reference is now also made to FIG. 2, which is a flowchart of a method 200 of matching between subscribers, based on their location, and optionally based on shopping interests, for a joint purchase transaction, according to some embodiments of the present invention. In the method, actions performed by client terminals 198, 199 and a central unit 197 are described.

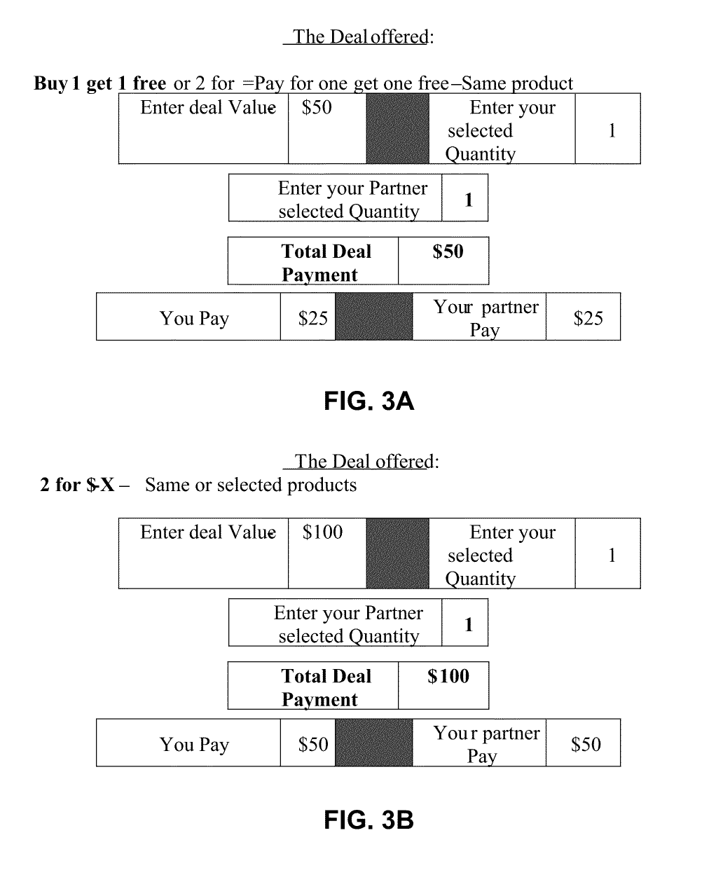

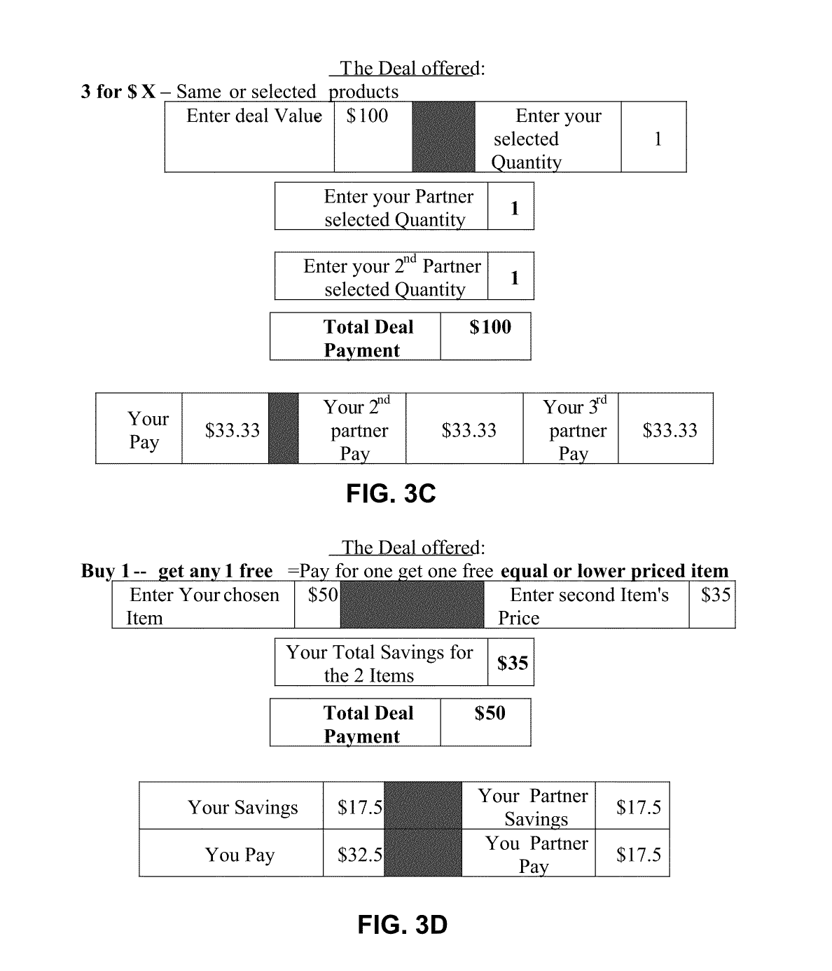

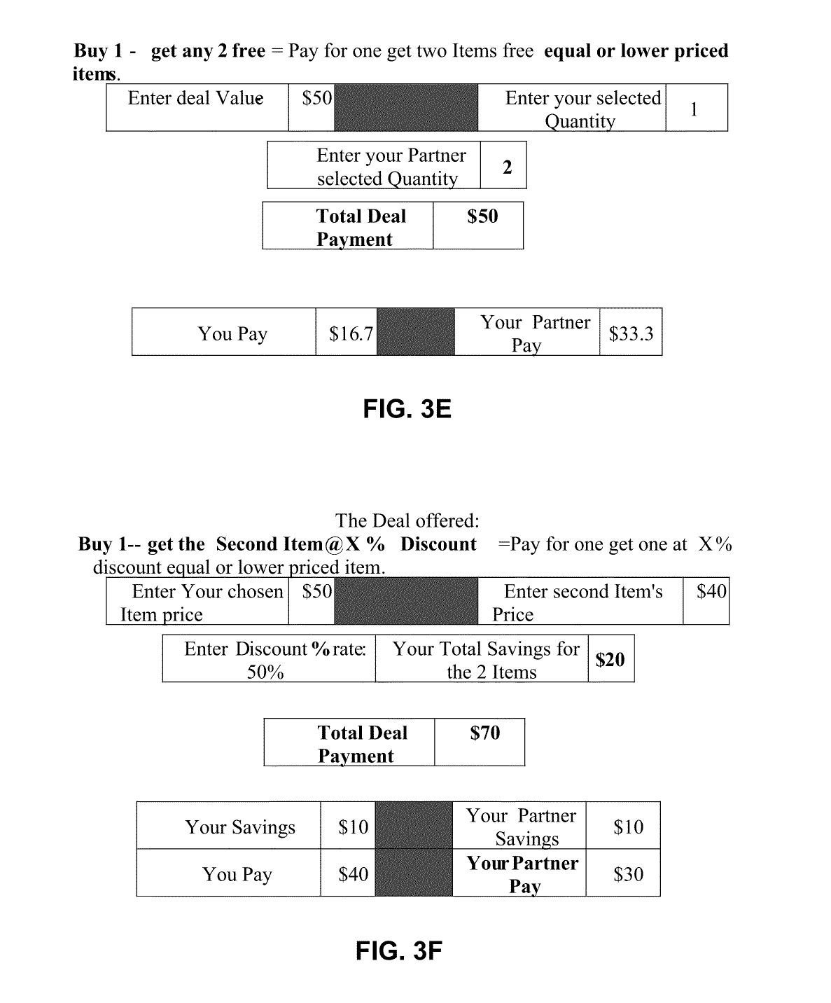

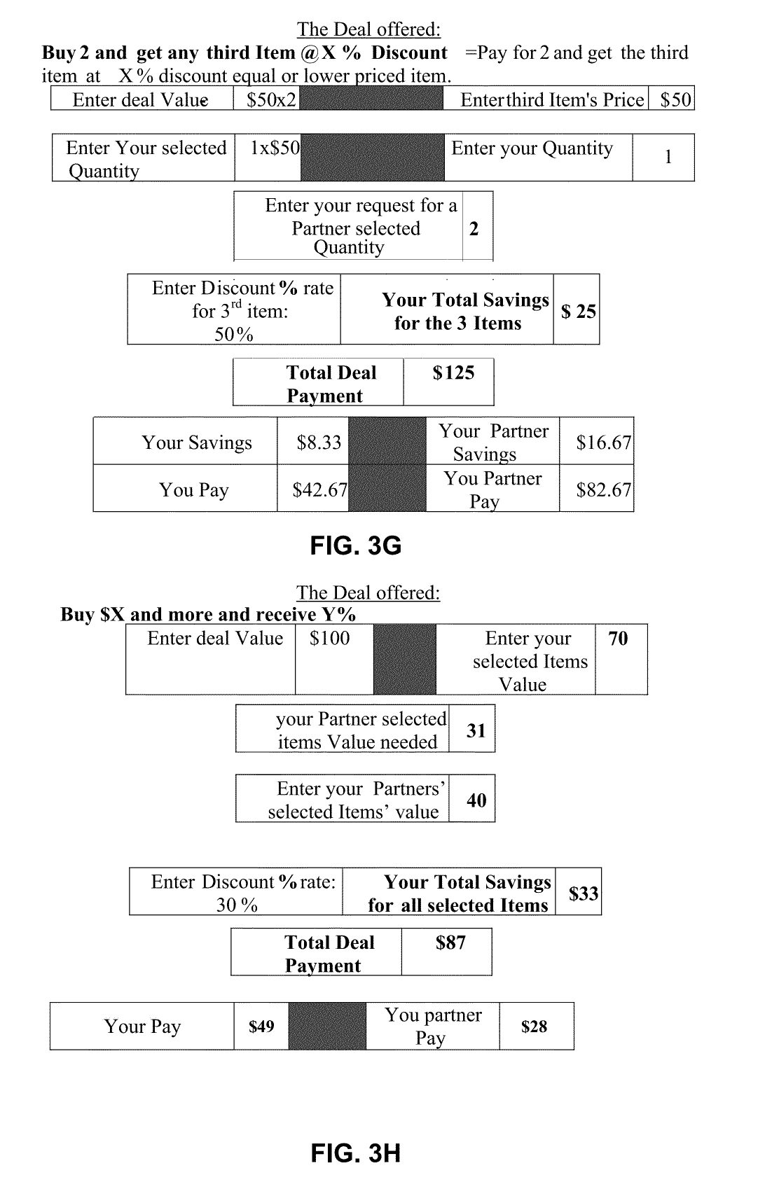

First, as shown at 201, a request for partners for a joint purchase of offered product(s) and/or service(s) is generated at a client terminal, such as 102, according to inputs of a subscriber. For example, the offer data may include the name of a store, the location of a store, which may be added automatically according to the current location of the user, a description of the offered product(s) and/or service(s), for example a 1+1 deal for pairs of shoes, a card index for car wash, a buy two shirts and pay for one deal, a 50% off the second item deal, a family pack deal of tooth brushes and/or the like. Optionally, the offer data further includes the terms at which the product(s) and/or service(s) are split among the partners of the joint purchase. For example, in a 1+1 deal for pairs of shoes the subscriber may define that each partner receives one pair of shoes. In another example, in a 50% off the second item deal, the subscriber may define that each partner pays 50% of the total price of the deal. In another example, in a pay for 10 and receive 11 item deal, the subscriber may define that one partner pays for and receives 6 items and the other pays for and receives 5 items. Optionally, the requesting subscriber uses a GUI of the client module 101 to input offer data about the offered product(s) and/or service(s) and/or to personalize the offer, for example to limit the time for joining the joint group and/or the number of units each participant is obliged to purchase. Optionally, the GUI of the client module 101 allows the subscriber to enter offer data, for example amount of items and/or price. Optionally, the client module 101 calculates and uses the GUI to present how much the requesting subscriber pays, how much each partners pays, the total saving, and/or the saving per participant. The GUI is optionally adapted to the type of the offer, for example the type of the deal. For example, FIGS. 3A-3G are a plurality of schematic and exemplary graphical user interfaces, each adapted to another deal type, according to some embodiments of the present invention. In another example, the request of the requesting subscriber defines a product and/or a service for sharing, for example a taxi, a meal, and/or a hotel room. In such a manner, a subscriber can locate a passerby which has similar needs and/or desires and would like to reduce costs.

Optionally, the offer includes gathering location and/or time data that define a meeting venue and/or time for a group of subscribers for facilitating the joint purchase. The gathering location and/or time data may be generated automatically, for example based on the location of the subscriber and/or the location of the retailer which offers the offer. For example, a predefined gathering location may be defined, by the system 100, for subscribers in a certain area, for example at the entrance of a mall and/or the like.

Optionally, a subscriber may submit a request before his arrival to a certain offering location. In such an embodiment, the subscriber selects a region and submits the request based on information about the offer and/or selects an offer from the offers database. When other subscribers, which are invited to participate in a respective joint purchase arrives at the certain offering location and accept the offer, the subscriber may receive a notification.

According to some embodiments of the present invention, the central unit 103 manages a database of location based offer records, referred to herein as offer database; each record of the offer database includes detail pertaining to an offer and the address and/or any other locational information at which the offer is available. In use, the location of a subscriber may be matched with the offer records to identify which offers are in proximity thereto. This allows the subscriber to select one of the offers and to send the request based thereupon. Optionally, the central unit 103 identifies when a number of subscribers are located in proximity to one or more places at which offers are available and sends them push notifications to let them know that the system 100 may be used to coordinate a joint purchase for them. In these embodiments a request is a response to push notification.

Optionally, the offer database is updated by the operator(s) of the system 100, retailers, and/or subscribers, for example via a designated GUI of the client module. For example, a retailer may upload offers for groups of purchasers to the offer database. For example, a store owner may offer a 50% off each item if ten subscribers or more are gathered for a joint purchase of 10 items. In another example, when a subscriber sends a request for partners for a joint purchase pertaining to an offer that is not recorded in the database, the system 100 extracts offer details, the location(s) of the retailer that offers the offer and/or the current location of requesting subscriber and adds them as a new record to the database of location based offers. In another example, the subscriber accesses a designated user interface that allows him to add data pertaining to one or more offers.

Optionally, the offer database may retrieve offers to subscribers based on various search queries, such as price, location, subscriber's ranking, store's ranking subscriber's social connections, and/or the like. Optionally, the offer database may retrieve offers to subscribers based a risk analysis of the offer, for example based on the ranking or history of participating subscribers, the ranking or history of the offering store, and/or price, and/or closing time.

According to some embodiments of the present invention, the central unit 103 includes a ranking mechanism that ranks subscribers according to their creditability and/or contribution to the database of location based offers. In such an embodiment, the rank of a subscriber may be updated based on the number of requests he made and/or updates he uploaded.

According to some embodiments of the present invention, the client module is integrated or interfaces with a navigation module. In such an embodiment, the location data is taken optionally automatically, from the destination field of the navigation module. Optionally, the user interface of the client module may be integrated with the user interface of the navigation module. In such an embodiment, the user inputs or selects, in addition to a destination address, a designated offer and/or a product or a service he or she would like to buy. If the input is a product and/or an offer, the central unit 103 may now match, for example using the offer database, one or more offers to the subscriber. The matched, selected and/or inputted offer is added to the request, for example similarly to the described above.

After the request is received, as shown at 202, a group of subscribers located in proximity to the requesting subscriber and/or the gathering location and/or time is identified, optionally by the central unit 103. Additionally or alternatively, the group includes subscribers, which are identified as subscribers who are intended to arrive to the proximity of the requesting subscriber and/or to the gathering location and/or time. Such subscribers may be identified by an analysis of a navigation module query which is entered by the subscriber to a navigation module, such as WAZE™, TomTom™, IGO™ and/or the like. In such an embodiment, the navigation module interfaces and/or integrated with the client module 101.

According to some embodiments of the present invention, the system 100 and method 100 allow integrating data of potential joint purchases in the navigation process of a navigation service. For example, subscribers of a social network of drivers may receive invitations to participate in joint purchases with other subscribers based on their current destination. In such an embodiment, a driver that drives to a certain retailer location, such as a store in a mall, and looking for partners for a certain offer, may use the system 100 to send invitation to drivers who set the mall as their destination and/or a route that passes in proximity to the mall. Additionally or alternatively, requests may be initiated by the central unit 103. In such embodiments, the central unit 103 identifies a group consisting of a plurality of subscribers who set a common location as a their destination in the navigation service and/or currently located at the common location and sends invitations thereto, optionally with a gathering location and/or time that is set in advance for joint purchases in the respective area, for example an entrance of a mall and/or a shopping center.

Optionally, as shown at 203, subscribers of the group are filtered according their preference settings. In such a manner, only subscribers who are looking for the product and/or service that matches their preferences are added to the group. Optionally, subscribers of the group are filtered according their privacy settings. In such a manner, only subscribers who define participating in a joint purchase with subscribers having a profile that matches the profile of the requesting subscriber are added to the group. For example, a subscriber who defined in her privacy setting that requests should be received from friends or friends of friends, based on social network connections, is not added to a group of a subscriber which is not socially connected thereto. In another example a subscriber may define in her privacy setting that requests should be received from a female subscriber, a pregnant subscriber, and/or a subscriber that have selected areas of interest, such as rock climbing and/or the like. Optionally, subscribers of the group are filtered according their location settings. In such a manner, only subscribers who define their current location as a location for potential purchases are added to the group. Optionally, subscribers of the group are filtered according their credibility ranking, for example as defined in the subscriber records. In such an embodiment, subscriber may define that they are ready to participate in joint purchases with subscribers that a credibility ranking in a certain range.

Now, as shown at 204, one or more invitations to participate in the joint purchase is sent to subscribers of the group. An invitation includes at least offer details and optionally the gathering location and/or time data. The invitations may be forwarded from the central unit 103 as short message service (SMS) messages, Multimedia Messaging Service (MMS) messages, TCP/IP message, such as a hypertext transfer protocol (HTTP) to the client terminals 101 of the subscribers, push notifications to the client terminals 101 of the subscribers and/or the like. Optionally, the invitations are sent directly from the client terminal 102 of the requesting subscriber. In such an embodiment, a list that includes the group members is sent to the requesting subscriber that uses the list for sending the invitations. As shown at 205, each invitee approves, ignores and/or declines the invitations. Optionally, the approval is for meeting the requesting subscriber at the gathering place for performing the joint purchase. Optionally, the approval is for participation in the joint purchase without actually meeting the requesting subscriber before the purchase. In such an embodiment, the response may include an electronically signed consent to participate in the purchase, a third party approval of an allocation of money to the requesting subscriber, for the offer, for example in a web-based service that allows to send and receive payments online, such as PayPal™.

Optionally, a potential saving calculator module calculates what the total savings of the joint purchase is, splits the savings among the invited subscriber and the requesting subscriber potential buyers, and presents the total amount to be paid for each of the invited subscriber. The calculation may be dynamically updated according to the number of invited subscriber who approved their participation in the joint purchase.

As shown at 206, when the invitee responses are received by the central unit 103, a joint purchase may be coordinated, for example by sending updates pertaining to the final participants to the approving invitees and the requesting subscriber. The coordination may include a chat session for finalizing the gathering venue and/or timing. Optionally, an update is sent for presentation to the requesting subscriber on his client terminal and optionally to other the subscribers who agreed to participate in the joint purchase, as shown at 207.

As described above, the invitees may be located in proximity to the subscriber, for example in the same shopping center and/or designate a visit to a location in proximity to the subscriber. As some of the invitees are on their way to the location of the subscriber, an indication of distance and/or estimated arrival time is calculated by the respective client module 101 and sent with the invitee responses. In such an embodiment, participants are informed about the distance and/or the estimated arrival time during the coordination. In another embodiment, the distance and/or estimated arrival time is calculated by the central unit 103. In such a manner, the requesting subscriber and/or other participant may determine whether they are willing to wait for the arriving subscriber or not.

Optionally, the invitee may communicate directly with the requesting subscriber and/or via the central unit 103. Optionally, a chat is established between the invitee(s) and/or the requesting subscriber. The chat may be a video chat, an audio chat, a video chat, and/or an instant messaging (IM) chat. The chat may be a multi participant chat which is held with 3 participants or more and/or a direct bidirectional communication between an invitee and a subscriber. Such a communication allows the invitee to request for more details and/or to suggest a new meeting venue and/or time for the joint purchase. Optionally, the invitation includes or includes a link to a dynamic object, such as a window, that presents the number of participating subscribers and optionally an up-to-date estimation about the number of available offered items and/or service rights, a price, and/or a total discount.

Optionally, the distance and the estimated arrival time of the requesting subscriber is calculated, based on his location and the set gathering place location, and added to the respective invitation.

Now, the requesting subscriber and approving subscriber(s) can meet at the gathering location and/or time and to conduct the joint purchase. In another embodiment, the requesting subscriber may accept the offer on behalf of himself and one or more approving subscribers. In such an embodiment, a meeting between the requesting subscriber and the approving subscribers is not needed.

Optionally, the client module 101 provides a direct access to a payment server, such as PayPal™, facilitating money transactions among subscribers for facilitating the joint purchase.

Optionally, as shown at 208, the central unit 103 updates the offer database based on the request of the requesting subscriber.

Optionally, as shown at 209, one or more of the participants of the joint purchase, for example the requesting subscriber and/or the approving subscriber(s), report to the central unit 103 about the outcome of the joint purchase and/or rank one or more of the other participants of the joint purchase. Optionally, subscribers may be ranked only in proximity to the offering location and/or in a coincidence to the joint purchasing event, for example no more than few hours after the joint purchasing. In such a manner, fraudulent ranking may be avoided or reduced.

The reporting may be performed by a response to a push message, for example by an answer to a ranking notification, and/or by a pull action, for example by access to designated web page. As described above, the central unit may manage subscriber records which include a credibility rank of the subscriber. The credibility rank may be updated according to the aforementioned reporting. For example, a subscriber ranking may be increased when he participates in a reported joint purchase and/or reduced when a complaint is filed against the subscriber. In another example, each subscriber ranks the credibility of other subscribers on a scale and the credibility level of the subscribers is determined accordingly.

Optionally, one or more of the participants of the joint purchase, for example the requesting subscriber and/or the approving subscriber(s), rank the retailer that provided the offer. In such a manner, the system 100 may be used to manage or update a retail ranking that is based on the purchasing experience of the subscribers.

Reference is now made to FIG. 4, which is a method of establishing communication among a plurality of subscribers based on location, according to some embodiments of the present invention. In the method, actions performed by client terminals 248 and a central unit 249 are described. In these embodiments, blocks 203-206 are as described in FIG. 2; however, new blocks 251-254 are described herein. First, as shown at 251 and 252, the locational data of a plurality of subscribers is received at the central unit 249 and monitored. For example, the client modules 248 (i.e. as client modules 101 above), which are described above and/or navigation modules, are used for monitoring the location of the subscribers and to forward the current locational data and/or navigation destination to the central unit 249 (i.e. as central unit 103 above). Now, as shown at 253, the locational data is analyzed to identify a group of subscribers who are currently located in proximity to an offering location of a suggested deal or about to be located in proximity to the offering location, for example subscribers who set the offering location or a location in proximity thereto as a navigation destination and/or set a navigation route that passes in proximity to the offering location. The suggested deal is optionally selected from a database of suggested deals which is updated by the operator, the subscribers, and/or retailers, for example as described above.

As shown at 203-205 and described above, an invitation may be each member sent to each member of the group of subscribers, optionally after filtering, and responses to the invitations may be gathered to allow coordinating a joint purchase among the responding invitees, for example as shown at 254. The outcome of the coordination, as described above and shown at 255 is presented to the subscribers of the group.

It is expected that during the life of a patent maturing from this application many relevant systems and methods will be developed and the scope of the term a central unit, a computing unit, a client terminal, and a network is intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method of coordinating a joint purchase, comprising:
monitoring the location of each of a plurality of subscribers;
receiving from a first of said plurality of subscribers an indication of a joint purchase of a suggested deal of a plurality of products in an offering location;
calculating a group of said plurality of subscribers who are located in proximity to said offering location;
sending at least one invitation indicative of said suggested deal to at least one member of said group;
receiving at least one response to said at least one invitation from said at least one member; and
coordinating said joint purchase between said first subscriber and said at least one member.

2. The method of claim 1, wherein said suggested deal is designated for a single purchase by a single customer.

3. The method of claim 1, wherein said receiving further comprises receiving price and content details pertaining to said suggested deal from said first subscriber; wherein said sending further comprises sending said price and content details to said at least one member.

4. The method of claim 1, wherein said receiving further comprises receiving gathering location data pertaining to said suggested deal from said first subscriber; wherein said sending further comprises sending said gathering location data to said at least one member.

5. The method of claim 1, wherein said suggested deal is an offer to purchase a plurality of articles at a discounted rate in relation to purchasing each said article separately.

6. The method of claim 1, wherein said calculating further comprises identifying shopping interests of each said subscriber and filtering said group according to a match between respective said shopping interests of said at least one member and at least one.

7. The method of claim 1, wherein said calculating further comprises identifying privacy preferences of each member of said group and filtering said group according to a match between said respective privacy preferences and at least one characteristic of said first subscriber.

8. The method of claim 1, wherein said calculating further comprises providing a plurality of social connections among said plurality of subscribers and using said plurality of social connections to identify said group based on social connections of said first subscriber.

9. The method of claim 1, further comprising managing a database of a plurality of suggested deals each associated with locational data; wherein said receiving comprises presenting at least some of said plurality of suggested deals to said first subscriber based its location and receiving from said first subscriber a selection indicative of one of said plurality of suggested deals.

10. The method of claim 1, wherein said suggested deal is for a plurality of articles; further comprising calculating a distribution of said plurality of articles among participants in said joint purchase and a respective discount per participant; wherein said sending further comprises sending said respective discount and said distribution to said at least one member.

11. The method of claim 1, further comprising managing a plurality of subscriber ranks each for another said subscriber, receiving a report indicative of the outcome of said joint purchase from at least one of said first subscriber and said at least one member and updating a respective said subscriber rank accordingly.

12. The method of claim 1, wherein said receiving comprises analyzing a navigation query of said first subscriber to extract said offering location, presenting said suggested deal to said first subscriber, and receiving a selection of said suggested deal by said first subscriber.

13. The method of claim 1, wherein said calculating comprises identifying at least one of said plurality of subscribers who set a navigation destination in proximity to said offering location and adding said at least one member to said group.

14. The method of claim 1, wherein said calculating comprises identifying at least one of said plurality of subscribers who set a navigation route that passes in proximity to said offering location and adding said at least one member to said group.

15. The method of claim 1, further comprising receiving an indication of the execution of said joint purchase and updating a credibility rank of at least one of said first subscriber and said at least one member accordingly.

16. A computer readable medium comprising computer executable instructions adapted to perform the method of claim 1.

17. The method of claim 1, further comprising acquiring a payment proof from a payment server and notifying said first subscriber about said acquisition.

18. A system of coordinating a joint purchase, comprising:
a database of a plurality of subscribers each associated with current locational data; a central unit; and
a plurality of client modules, each installed in one of a plurality of client terminals and configured to receive a purchasing request indicative of a suggested deal in an offering location from a first of said plurality of subscribers, to extract a respective said locational data from a hosting said client terminal, and to forward said purchasing request and said respective locational data to said central unit;
wherein said central unit identifies a group of said plurality of subscribers who are located in proximity to said offering location according to said respective locational data, sends at least one invitation to at least one member of said group, and coordinate a joint purchase according to at least one response of said at least one member to said at least one invitation.

19. A method of coordinating a joint purchase, comprising:
providing locational data of a plurality of subscribers;
identifying a group of said plurality of subscribers who is or about to be in proximity to an offering location of a suggested deal of a plurality of products according to said locational data;
sending an invitation indicative a joint purchase of said plurality of products to a plurality of members of said group;
receiving a plurality of responses to said invitation from at least some of said plurality of members; and
coordinating said joint purchase between said at least some plurality of members.

20. The method of claim 19, wherein said locational data comprises a plurality of navigation destinations of said plurality of subscribers; wherein said identifying comprises identifying which of said plurality of subscribers set a navigation destination in proximity to said offering location.

21. The method of claim 19, wherein said locational data comprises a plurality of navigation destinations of said plurality of subscribers; wherein said identifying comprises identifying which of said plurality of subscribers set a navigation route passing in proximity to said offering location.

22. The method of claim 20, wherein said plurality of navigation destinations are received from a plurality of navigation modules each installed in another of a plurality of client terminals.

23. The method of claim 19, wherein said suggested deal is acquired from a database comprising a plurality of suggested deals each associated with respective locational data based on a match between said offering location and respective said locational data.
